(19) United States
(12) Patent Application Publication
(10) Pub. No.: US 2003/0052586 A1
(43) Pub. Date: Mar. 20, 2003

(54) High voltage discharge lamp and ballast connector

(76) Inventors: Michael J. Frappier, Concord, NH (US); Galen A. Stearns, Windham, NH (US); Daniel D. Devir, South Sutton, NH (US)

Correspondence Address: William E. Meyer, Osram Sylvania Inc., 100 Endicott Street, Danvers, MA, 01923, US

(21) Appl. No.: 09/957,553

(22) Filed: Sep. 20, 2001

(51) Int. Cl. H01J 5/54

(52) U.S. Cl. 313/318.09

(57) ABSTRACT

Connector for a discharge lamp and ballast assembly, as well as a lamp assembly including the connector. The connector is a conductive ribbon that includes a plurality of pinch or wedge-shaped wire slots for receiving lead wires from the discharge lamp and from the power supply. The connector is made of a material and is suitably shaped to provide flexibility to accommodate thermal expansion and contraction of the lamp, yet provide for proper positioning of the lamp in a reflector housing or the like. Disassembly of the connections and replacement of the lamp is facilitated and does not result in permanent damage to the lamp.

### BACKGROUND OF THE INVENTION

Neon lamps are typically elongated tubes with diameters ranging from 5 millimeters to an inch. In view of their relatively low power consumption and long operating life, neon lamps are often used in automotive applications, such as top-brake lights or direction (turn) signal lamps. Neon lamps as well as other discharge lamps are ignited with high voltage that depends in part on the overall length of the lamp. Voltages in the kilovolt range are common.

A silicone lead wire is typically required to connect discharge lamps to high voltage sources. In addition, a resilient boot, typically made of molded silicone rubber, is used to provide a moisture-proof seal for the connection between the contact pin of the lamp and an electrical terminal supplying power to the lamp. The boot also serves to accurately locate the discharge lamp in the housing, cushion the lamp against shock and vibration, and provide a flexible expansion and contraction joint in the event of thermal expansion or contraction. U.S. Pat. No. 5,610,472, the disclosure of which is hereby incorporated by reference, discloses such a boot in connection with a discharge lamp connector.

However, for low voltage applications, such a molded silicone boot and silicone lead wire are not cost-effective. In addition, the molded silicone boot has high insertion stress to the lamp press area, and does not allow for removal once the connector has been installed. Removal would permanently damage both the lamp and connector. Elimination of the silicone boot would eliminate the mechanical insertion force, and would allow for removal of the lamp without causing permanent lamp damage.

It is therefore an object of the present invention to provide a discharge lamp connector that allows for disassembly of the connection and replacement of the lamp without permanently damaging any of the component parts of the assembly.

It is a further object of the present invention to reduce or eliminate the mechanical insertion force necessary when a conventional silicone sealing boot is present.

### SUMMARY OF THE INVENTION

The problems of the prior art have been overcome by the present invention, which provides a connector for a discharge lamp and ballast assembly, as well as a lamp assembly including the connector. The connector is a conductive ribbon that includes a plurality of pinch or wedge-shaped wire slots for receiving lead wires from the discharge lamp and from the power supply. The connector is made of a material and is suitably shaped to provide flexibility to accommodate thermal expansion and contraction of the lamp, yet provide for proper positioning of the lamp in a reflector housing or the like. Disassembly of the connections and replacement of the lamp is facilitated and does not result in permanent damage to the lamp.

### BRIEF DESCRIPTION OF THE DRAWINGS

FIG. 1 is a perspective view of one embodiment of the connector in accordance with the present invention;

FIG. 2 is front view of a wire connector in accordance with the present invention;

FIG. 3 is a top cross-sectional view of a wire connector shown with a wire inserted in accordance with the present invention;

FIG. 4 is a cross-sectional view of the connector held by a boss in accordance with the present invention; and

FIGS. 5A-5E are schematic layouts of alternative wire connectors in accordance with the present invention.

### DETAILED DESCRIPTION OF THE INVENTION

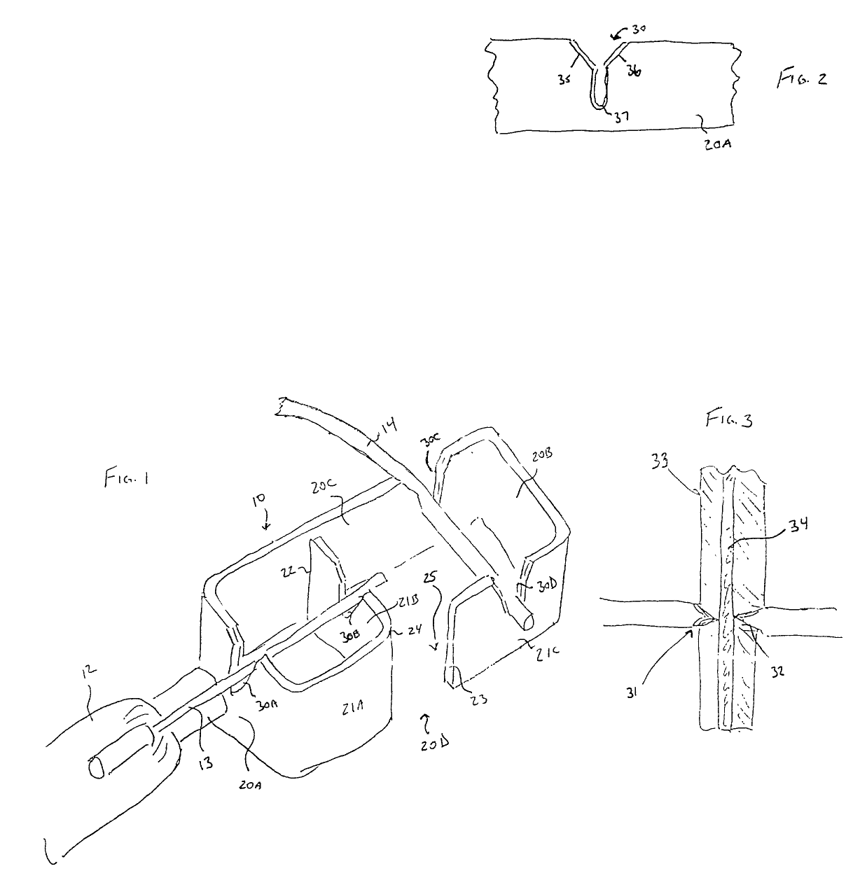

Turning first to FIG. 1, there is shown a connector 10 in accordance with one embodiment of the present invention. Also shown is a portion of discharge lamp 12, having at least one electrical wire lead 13, and a second wire lead 14 in electrical communication with a power supply (not shown) to supply power to the discharge lamp 12. In general, the discharge lamp has an elongated configuration, although the present invention is not so limited. The discharge lamp 12 is preferably a neon lamp, although other discharge lamps are operable with the connector of the invention and are within the scope of the present invention.

In the embodiment of FIG. 1, the connector 10 is a single piece conductive ribbon in a cursive pattern shaped as the arabic numeral “6”, having an end 20A facing the lamp 12, an opposite end 20B spaced from end 20A and joined to end 20A by a first side 20C, and a second open side 20D opposite side 20C. Side 20D includes a first portion 21A extending from end 20A substantially parallel to side 20C, and a second portion 21B bent at elbow 24 towards side 20C at about a 90° angle to first portion 21A. Preferably the second portion 21B terminates in a free end 22 as shown, and extends a sufficient length towards the side 20C to accommodate a wire slot 30B as discussed in greater detail below. Side 20D also includes a third portion 21C extending from end 20B substantially parallel to side 20C. Third portion 21C terminates in free end 23. Free end 23 and elbow 24 define between them an aperture 25 as shown.

The configuration of the connector 10 of FIG. 1 allows for spring-like flexibility, so that the connector 10 can accommodate thermal expansion and contraction of the discharge lamp and associated components. In addition, the flexibility or spring-like action of the connector 10 will allow the discharge lamp 12 to be properly positioned (e.g., centered) in a reflector housing or other assembly. Suitable materials of construction for the connector 10 include electrical conductors such as metal, stainless steel, plated phosphor, plated copper, plated brass, bronze, etc., preferably those which are rust-proof. Although flexible, the conductor 10 is sufficiently rigid or stiff to receive and grasp wires as discussed below.

The connector 10 includes a plurality of wire slots 30 formed in respective side walls of the connector, shown in greater detail in FIGS. 2 and 3. Preferably each wire held by the connector 10 is inserted into two such slots 30, although those skilled in the art will appreciate that fewer or more could be used. Each wire slot 30 is designed with opposed cutting edges 31, 32 (FIG. 3), configured as a wedge-shape so that the space between the edges 31, 32 is slightly smaller than the outer diameter of the wire to be inserted in the slot 30. Upon insertion of the wire into the slot 30, the cutting edges 31, 32 displace the outer insulation 33 of the wire and contact the wire conductor 34 as shown in FIG. 3, creating an electrical connection. The wire remains removably secured in the wire slot as a result of the press fit created. By spreading the wire slots, the lamp or power lead easily can be removed, and the wire slots can then be re-pressed together for further use.

In order to facilitate insertion of the wire into each slot 30, preferably the slot is formed with an entry that is wider than the outer diameter of the wire. For example, the slot 30 can include angled sides 35, 36 which converge towards each other in the direction towards the bottom 36 of the slot 30, which bottom is preferably closed, as best seen in FIG. 2. In this embodiment, the two angled sides 35, 36 converge to the extent that the narrowest distance between them is smaller than the outer diameter of the wire in order to displace the insulation 33 as discussed above, and thereby create electrical communication between the conductor 34 and the connector 10.

In the particular embodiment illustrated in FIG. 1, the lamp lead 13 is pressed into wire slots 30A and 30B, and the power lead 14 is pressed into wire slots 30C and 30D. The contact edge of the slots cuts through the insulation in the wires, creating electrical communication between the conductor in the wires and the connector 10. The connector thus allows for rapid coupling and decoupling of the leads, and disassembly of the connections and lamp replacement without permanent damage to the lamp itself. The wire slots 30 do not lose their functionality even after numerous coupling and decoupling operations. The leads need not be perpendicular to each other.

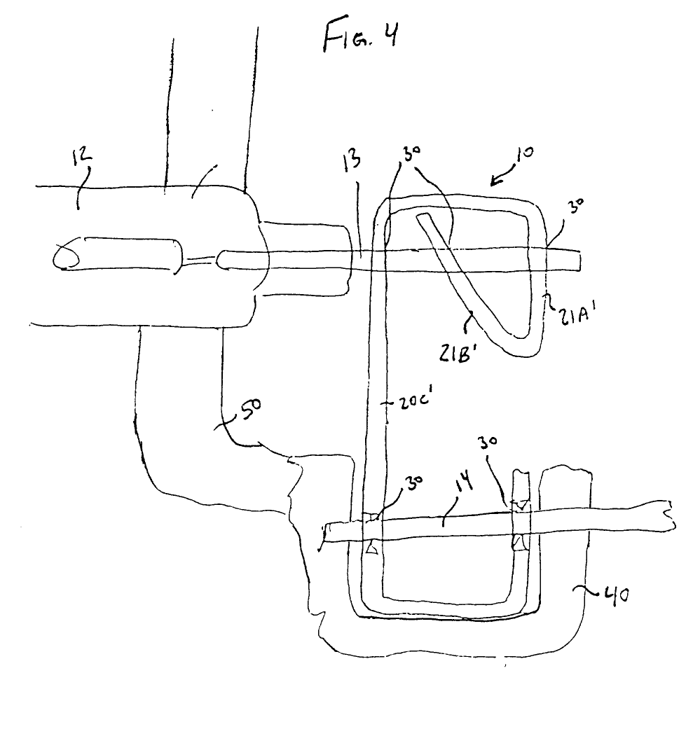

Turning now to FIG. 4, a connector 10 is shown held in a boss 40 cavity in a housing which can be made from a rigid plastic such as polycarbonate. The cavity of the boss 40 is shaped to hold the connector 10 yet allow the flexibility of the connector 10 to function and thereby accommodate thermal expansion or contraction of the lamp 12 with respect to the lamp housing. More specifically, the boss secures only a portion of connector 10, preferably a portion of the connector remote from the lamp 12, thereby allowing the remaining portion of the connector to flex as the lamp 12 expands or contracts. The connector 10 can be held in place in the boss 40 by any suitable means, including ridges, grooves or other similar latching features within the skill in the art.

As is apparent from FIG. 4, the location of the wire slots 30 is not critical; in the embodiment of FIG. 4, two such slots are formed in longitudinal side member 20C′, one for lamp lead 13 and the other for power lead 14. In addition, bent portion 21B′ is bent more than 90° (relative to side 21A′), allowing the lamp lead 13 to be secured in three substantially linearly aligned wire slots 30. Since the wire leads are typically flexible, the wire slots 30 need not be linearly aligned, however.

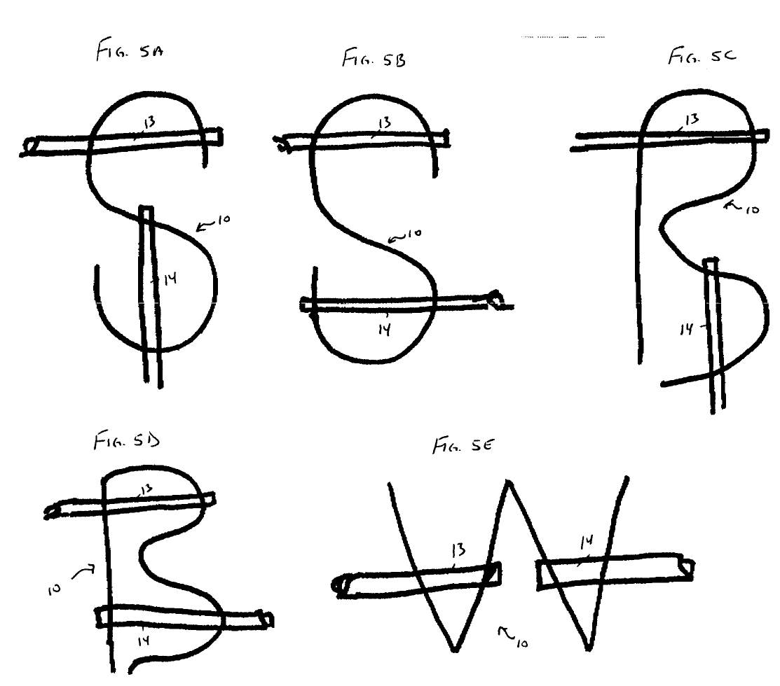

FIGS. 5A-5E illustrate other possible configurations of the connector 10, including a letter a letter “S” shape (FIGS. 5A and 5B), and a letter “B” shape (FIGS. 5C and 5D), and a letter “W” shape (FIG. 5E). Thus, additional bends may be added to the connector to provide for increased flexibility and to form different sized connectors. Equivalent patterns may be similarly devised. Those skilled in the art will appreciate that the location of the lamp wire lead 13 and wire lead 14 in electrical communication with the power supply can be reversed.

What is claimed is:

1. A connector for establishing electrical connection between a discharge lamp and a power supply therefor, comprising:
a flexible conductive ribbon arranged in a cursive pattern and having at least one longitudinal edge;
said ribbon having a first slot in a longitudinal edge thereof, said first slot being adapted to receive and grasp a first electrical wire conductor;
said ribbon having a second slot in a longitudinal edge thereof, said second slot being adapted to receive and grasp a second electrical wire conductor;
whereby said first wire conductor is electrically connected to said second wire conductor by means of said ribbon.

2. A connector in accordance with claim 1, wherein said first and second slots are wedge-shaped.

3. A connector in accordance with claim 1, wherein:
the longitudinal edge which has said first slot also has a third slot therein, said cursive pattern being arranged so that said first wire conductor is received and grasped by said first and third slots.

4. A connector in accordance with claim 3, wherein said first, second and third slots are wedge-shaped.

5. A connector in accordance with claim 3, wherein:
the longitudinal edge which has said second slot also has a fourth slot therein, said cursive pattern being arranged so that said second wire conductor is received and grasped by said second and fourth slots.

6. A connector in accordance with claim 5, wherein said first, second, third and fourth slots are wedge-shaped.

7. A connector in accordance with claim 5, wherein said cursive pattern corresponds to the arabic numeral “6”.

8. A connector in accordance with claim 5, wherein said cursive pattern corresponds to the letter “W”.

9. A connector in accordance with claim 5, wherein said cursive pattern corresponds to the letter “S”.

10. A connector in accordance with claim 5, wherein said cursive pattern corresponds to the letter “B”.

11. A connector in accordance with claim 7, wherein said cursive pattern is arranged so that said first slot is near the tip of the “6”, said third slot is further away from the tip of the “6” and aligned with said first slot so as to receive said first wire conductor.

12. A conductor in accordance with claim 11, wherein said cursive pattern is arranged so that said second and fourth slots are at the lower body of the “6” and aligned with one another so as to receive said second wire conductor.

13. A lamp assembly, comprising:
a discharge lamp having a first electrical lead;
a connector for electrically connecting said discharge lamp to a second electrical lead in electrical communication with a power supply, said connector comprising:
a single-piece conductive clip having a plurality of edges, said clip having a first wedge formed in one of said edges for receiving and securing said first electrical lead, and a second wedge formed in one of said edges for receiving and securing said
second electrical lead so as to thereby place said discharge lamp in electrical communication with said power supply.

14. The lamp assembly of claim 13, wherein said discharge lamp is a neon lamp.

15. The lamp assembly of claim 13, further comprising a reflector associated with said discharge lamp, and whereby said conductive clip orients said discharge lamp with respect to said reflector.

16. The lamp assembly of claim 15, wherein said conductive clip is formed of a material adapted to accommodate thermal expansion and contraction of said lamp without deleteriously altering the orientation of said lamp with respect to said reflector.
